(19) United States
(12) Patent Application Publication
(10) Pub. No.: US 2011/0004701 A1
(43) Pub. Date: Jan. 6, 2011

(54) PROVISIONING HIGHLY AVAILABLE SERVICES FOR INTEGRATED ENTERPRISE AND COMMUNICATION

(76) Inventors: Debashish Panda, Delhi (IN); Nayan Kumar Jain, Ghaziabad (IN)

Correspondence Address: Geoffrey Gelman, 14 Berkeley Pl, Brooklyn, NY, 11217, US

(21) Appl. No.: 12/647,281

(22) Filed: Dec. 24, 2009

(30) Foreign Application Priority Data
Dec. 29, 2008 (IN) 3306/CHE/2008

(51) Int. Cl. G06F 15/173

(52) U.S. Cl. 709/242

(57) ABSTRACT

A development, deployment and execution environment for a plurality of application components present in a distributed system in a service oriented architecture paradigm, the plurality of application components comprising both enterprise application components and communications application components and a method for application component life cycle management as well as registration, discovery, routing and processing of both synchronous and asynchronous service requests among the plurality of application components.

### RELATED APPLICATIONS

The present application claims the benefit of priority of the following foreign patent application: India Patent Application No. 3306/CHE/2008, filed Dec. 29, 2008, entitled “A METHOD AND SYSTEM FOR ROUTING SERVICE REQUESTS IN AN INTEGRATED ENTERPRISE AND COMMUNICATION APPLICATION ENVIRONMENT”, the entirety of which is incorporated by reference herein.

### FIELD OF THE INVENTION

This invention relates to the field of Enterprise Communication Applications (ECAs) and more particularly to development and execution environments for ECAs.

### BACKGROUND

An Enterprise Communication Application (ECA) comprises an enterprise application (for example, pricing, customer relationship management, sales and order management, inventory management, etc.) integrated with one or more communications applications (for example, internet telephony, video conferencing, instant messaging, email, etc.). The integration of enterprise applications with real-time communications in ECAs may be used to solve problems related to human latency and a mobile workforce. Human latency is the time for people to respond to events. As such, human latency reduces an enterprise's ability to respond to customers and manage time-critical situations effectively. As an example, consider an Inventory Management System (IMS) which displays stock levels to users in a user-interface. In such an IMS, critical stock situations such as shortages and surpluses become visible only when a user logs into the system. A simple extension of such an IMS would be to incorporate instant-messaging so that the concerned users can be messaged as and when critical stock situations arise. A further extension would be to integrate a present system with the IMS so that messages are sent only to users who are available for taking action.

The increasingly mobile workforce is another key area in which deploying ECAs can offer advantages. For example, a company with its salespersons located in far-flung areas may use an ECA to ensure that all its salespersons have access to reliable and up-to-date pricing information and can, in turn, update sales data from their location.

The contact center applications are a prime example of ECA. A contact center solution involves multimedia communications as well as business workflows and enterprise applications for the contact center e.g. outbound telemarketing flows, inbound customer care flows, customer management, user management etc.

Examples of ECAs include (a) applications that notify the administrators by email in the event of a problem condition in the stock situation of an inventory, (b) applications that help to resolve customer complaints by automatically notifying principal parties, (c) applications that prevent infrastructure problems by monitoring machine-to-machine communications, then initiating an emergency conference call in the event of a failure, (d) applications to organize emergency summits in to address a significant change in a business metric, such as a falling stock price, (e) applications that confirm mobile bill payments, (f) applications for maintaining employee schedules, (g) applications that provide present status to know which users can be contacted in a given business process at any time, and (h) applications that facilitate communication and collaboration across multiple medium of communication according to business processes and workflows of the organization.

With the advent of new communications technologies such as voice, video, and the like, the advantages of combining communications applications with enterprise applications are all the more numerous. However, integrating communications applications with enterprise applications is a non-trivial problem and involves considerable effort during application development. This is because the requirements of enterprise applications and communications applications differ greatly. Communications applications such as telecom switching, instant messaging, and the like, are event-driven or asynchronous systems. In such systems, service requests are sent and received in the form of events that typically represent an occurrence requiring application processing. Further, communications applications are typically made of specialized light-weight components for high-speed, low-latency event processing. Enterprise applications, on the other hand, typically communicate with each other through synchronous service requests using Remote Procedure Call (RPC), for example. Further, application components in enterprise applications are typically heavy-weight data access objects with persistent lifetimes.

An ECA must solve the problem of integrating communications applications and enterprise applications. In a typical ECA, the communication applications would direct a burst of asynchronous service requests (or events) to the enterprise applications at intermittent intervals. The enterprise application should be able to process the events received from the communication applications as well as synchronous service requests received from users or other enterprise application components in the system; considering the ordering, prioritization and parallelism requirements of the service requests. Without suitable integration with clear identification of the service request processing requirements may lead to improper throughput as well as response times for the service requests.

FIG. 1 shows one of the existing solutions for routing asynchronous service requests to enterprise application components 104 hosted by an enterprise application server 102 (e.g. Java 2 Platform, Enterprise Edition (J2EE)). This approach involves the use of Messaging Application Programming Interfaces (APIs) such as Java Message Service (JMS). A JMS implementation can be integrated with J2EE by using JMS in conjunction with the Message-Driven Beans (MDBs) of J2EE. However, such an approach is problematic since it does not make use of a Service Component Architecture (SCA) for communications applications. In the absence of containers that natively support event-driven applications, much development effort is required. For example, event processing with respect to ordering and parallelism, henceforth referred to as process control may conveniently be implemented in a container. As such, a developer creating an application using the container only needs to configure the process control for the application. Since Messaging APIs do not incorporate process control, a developer needs to spend considerable effort in coding for process control in the application. Further, this approach requires the developer to implement routing components 110 and a queue connection 112 to encode the message routing logic within the enterprise application server. Further yet, no universal standards exist regarding the Messaging APIs to be used. Thus, for example, a first application which is a JMS client may communicate with a second application only if the second application is a JMS client.

FIG. 2 shows another solution for sending asynchronous service requests to enterprise applications. In this approach, enterprise application component 204s are hosted by an enterprise application server 202 (e.g. J2EE) and communications application component 208s by a communications application server 206 (e.g. Java Advanced Intelligent Networks (JAIN) Service Logic Execution Environment (SLEE)). Such an approach takes advantage of the container-based approach for developing and deploying applications. However, such an approach still requires considerable development effort while integrating enterprise application component 204s with communications application server 206. For example, for each enterprise application integrated with JAIN SLEE, a resource adapter particular to that enterprise application needs to be implemented by the developer. Further, the requirement of separate application servers increases the effort during deployment and maintenance.

The preceding consideration of the prior art shows that developing and deploying ECAs is made difficult by the differing requirements of communications and enterprise applications. Thus, a need exists for a development and execution environment which (a) provides all the advantages of a container-based approach to application development for both communications and enterprise applications, and (b) allows for communications and enterprise applications to be integrated and co-exist without additional development effort.

### SUMMARY OF THE INVENTION

The present invention describes a DACX ComponentService framework which provides an execution environment to a plurality of application components, the plurality of application components including both enterprise application components and communications application components. The DACX ComponentService framework provides facilities for: (a) A container-based development of both enterprise applications and communications applications, and (b) Seamless integration and co-existence of enterprise applications with communications applications without additional development effort. Further, the plurality of application components may be hosted by the nodes of a distributed system. Thus, the DACX ComponentService framework can be used to develop and integrate enterprise applications and communications applications in a distributed system.

According to a preferred embodiment of the present invention, the DACX ComponentService framework provides a method for routing both synchronous and asynchronous service requests among a plurality of application components hosted by the nodes in a distributed system. A component service and associated application component are registered at a set of nodes in the DACX ComponentService framework. A requesting node in the DACX ComponentService framework requests for a service registered with the DACX ComponentService framework. The requesting node sends a request for a service reference for the service. In response to the request a first node is identified where an application component instance of the application component associated with the service is to be created. The information about the application component instance and service method is encoded into a stub and sent to the requesting node.

The requesting node uses the stub to send service request for the service. The service request is routed to an execution node where the application component instance is running The execution node may be the first node identified or a different node where the service is registered. The physical address of the execution node is retrieved by DACX ComponentService framework during runtime using the information about the application component instance contained in the service request. The property of determining the execution node during runtime makes the stub highly available. The service request is submitted in a message queue associated with the service. Queuing policy for the service is defined during registration of the service. Each message queue is assigned to a queue group. A queue group is configured with a scheduler and a thread pool. The thread pool has parameters to control minimum or maximum number of threads, thread priority, and other thread pool parameters. The scheduler schedules the submission of the service request from the message queue into a thread pool according to a scheduling algorithm. A thread is allocated from the thread pool to an application component instance which is going to execute the service request. The execution of a service request depends on service method invocation type of service method in the service request. Service method invocation type may be synchronous or asynchronous. For an asynchronous invocation, the service request may carry an additional response handler parameter. A delegate of the response handler parameter is created during execution which encodes return value of the service method invoked, into a response message and communicates it back to the requesting node. The response message is decoded at the requesting node to retrieve the return value of the service method.

During the execution of the service request by the thread from thread pool, DACX ComponentService framework keeps track of threads which execute the service request and subsequent service requests generated by them by assigning universally unique flow ids to the threads of execution. The flow ids are propagated and assigned based on the service method invocation type in the service requests. The flow ids are then logged by the logger for every log message, providing unique flow information of logged messages spanning across multiple nodes in the distributed system.

### BRIEF DESCRIPTION OF THE DRAWINGS

FIG. 1 is a block diagram showing asynchronous invocation from a communications application to an enterprise application using Messaging APIs.

FIG. 2 is a block diagram showing asynchronous invocation from a communications application server to an enterprise application server.

FIGS. 3A and 3B are schematics representing the DACX ComponentService Framework in a distributed system, in accordance with an embodiment of the invention.

FIG. 4 is a schematic showing an exemplary embodiment of Drishti Advanced communication Exchange or DACX, in accordance with an embodiment of the invention.

FIG. 5 is a schematic of the component controller of the DACX ComponentService framework, in accordance with an embodiment of the invention.

FIG. 6 is a flow diagram illustrating a method for routing service requests in DACX Component Service Framework, in accordance with an embodiment of the invention.

FIG. 7 is a flow diagram illustrating registration of a service with DACX ComponentService Framework, in accordance with an embodiment of the invention.

FIG. 8 is a flow diagram illustrating the service discovery process, in accordance with an embodiment of the invention.

FIG. 9 is a flow diagram illustrating the process of execution of a service request, in accordance with an embodiment of the invention.

FIG. 10 is a flow diagram illustrating the process of routing a service request from a requesting node to an execution node, in accordance with an embodiment of the invention.

FIG. 11A and FIG. 11B are flow diagrams illustrating execution of a service method in a service request having asynchronous invocation, in DACX 304, in accordance with an embodiment of the invention.

FIG. 12A and FIG. 12B are flow diagrams illustrating execution of a service method in a service request having synchronous invocation, in DACX 304, in accordance with an embodiment of the invention.

FIG. 13 is a flow diagram illustrating example of a scheduling algorithm, in accordance with an embodiment of the invention.

FIG. 14 is a flow diagram illustrating the process of rewiring of an application component instance in case of node failures, in accordance with an embodiment of the invention.

FIG. 15 is a flow diagram illustrating the steps of flow id generation of threads executing service requests, in accordance with an embodiment of the invention.

FIG. 16 is a schematic representing a sample hierarchy of a primary service request and subsequent secondary service requests and flow ids of threads executing the primary and secondary service requests, in accordance with an embodiment of the invention.

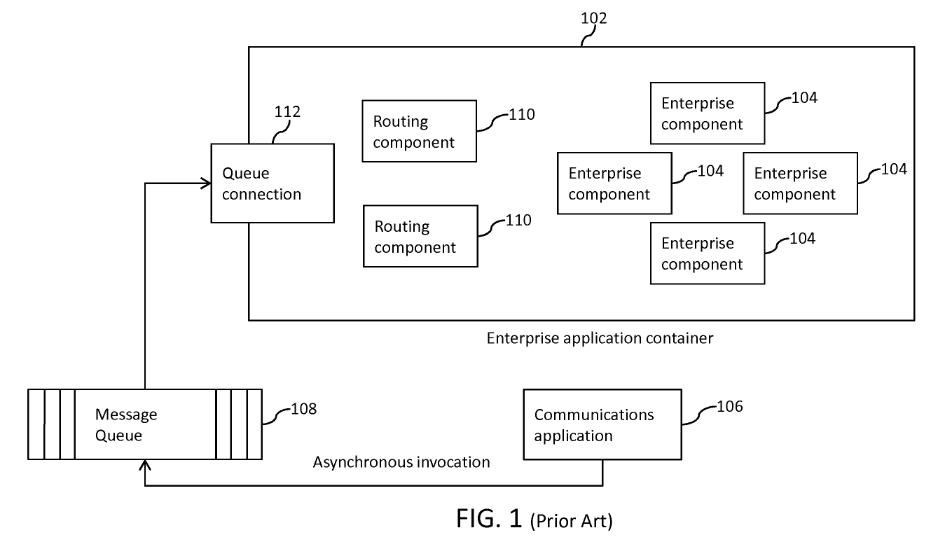

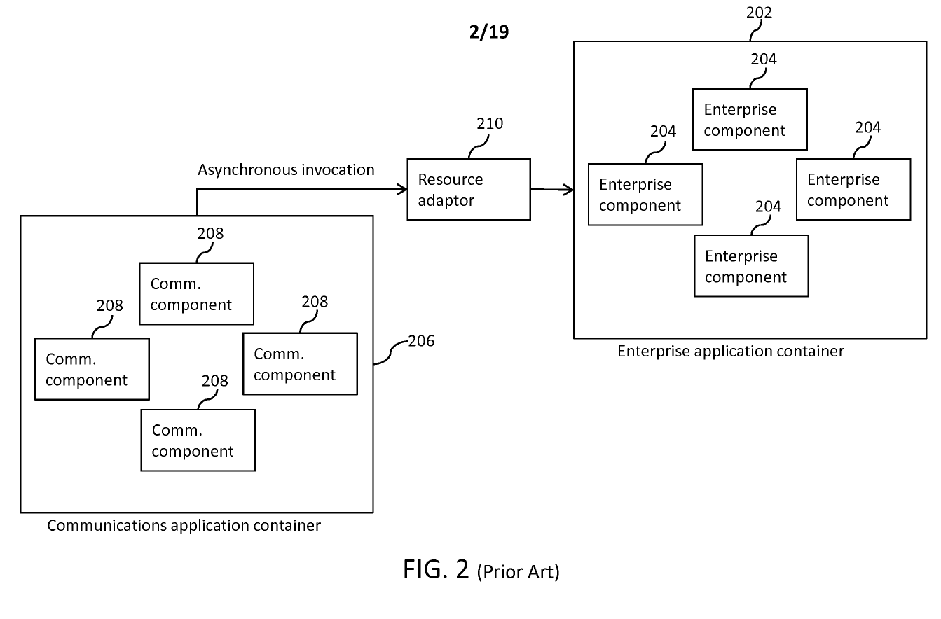

### DETAILED DESCRIPTION OF THE DRAWINGS

DACX ComponentService framework provides advantages of a container-based approach to application development for both enterprise applications and communications applications. In such an approach, problems of application integration and process control are solved by an application container. Moreover, DACX ComponentService framework does not require additional development work in terms of implementing routing components 110 and queue connection 112.

Further, DACX ComponentService framework does not require additional development work in terms of implementing resource adapter 210s while integrating enterprise applications and communications applications. DACX ComponentService framework provides an application container for both enterprise application components (EACs) and communication application components (CACs). An EAC typically makes synchronous service requests and in turn, provides synchronous processing of the service requests. On the other hand, a CAC typically makes asynchronous service requests and in turn provides asynchronous processing of the service requests. DACX ComponentService framework addresses the problem of integrating the communications applications and the enterprise applications at the level of the application container itself DACX ComponentService framework provides configuration options using which application developers may integrate the enterprise application component and the communications application component.

In the following description numerous specific details are set forth to provide a more thorough description of the present invention. Preferred embodiments are described to illustrate the present invention, not to limit its scope, which is defined by the claims. Those of ordinary skill in the art will recognize a variety of equivalent variations on the description that follows.

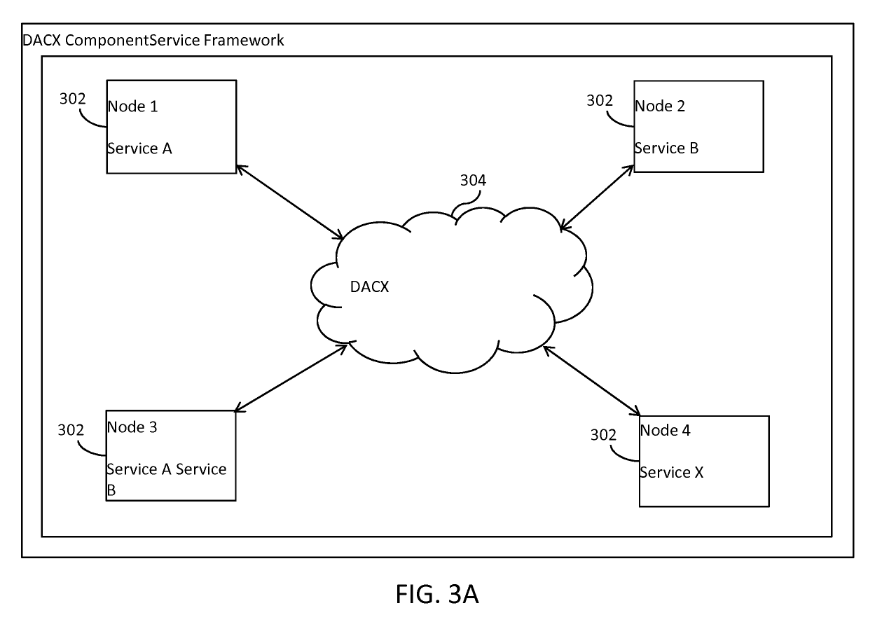

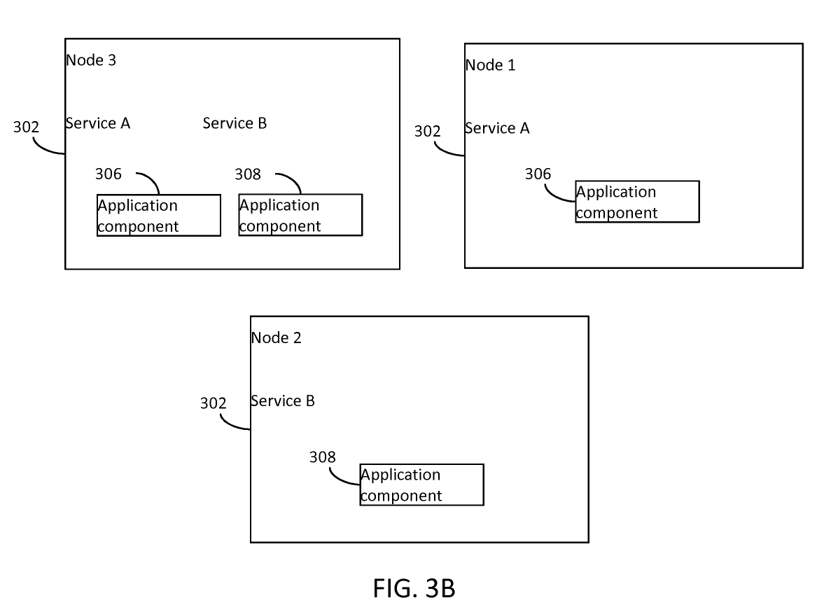

FIGS. 3A and 3B are schematics representing the DACX ComponentService Framework in a distributed system, in accordance with an embodiment of the invention. According to an embodiment, the DACX ComponentService Framework comprises a plurality of nodes and Drishti Advanced Communication Exchange or DACX 304. FIG. 3A illustrates 4 nodes—node-1 302, node-2 302, node-3 302, and node-4 302. A node can be, for example, a computer system. According to an embodiment, each of the plurality of nodes 302 hosts DACX 304. A node may have one or more services registered. A service has one or more methods, each method having an invocation type—synchronous or asynchronous. Each service is associated with an application component capable of executing the service. An application component is a building block for an application. Application components expose services to be used by other services and consume exposed services to achieve the desired functionality of the application components. An application component may be intended to perform any specific function in the enterprise communication application. To run an application component at a node, an instance of the application component is created at the node. The instance of an application component is referred to as an application component instance.

A node comprises application component associated with the service registered at the node. For example, service A is registered with node-1 302, service B is registered with node-2 302, and services A and B are both registered with node-3 302. Thus, node-1 302 comprises application component 306 associated with service A; node-2 302 comprises application component 308 associated with service B; node-3 302 comprises both application component 306 and application component 308. A service X is registered with Node-4 302.

Further a service may be a component service or a non component service. Component services are highly available services. A highly available service is registered with multiple nodes. The presence of a component service at multiple nodes allows failover of application components from one node to another node making the service highly available in case of node failure(s). Failover of application components implies recreation of an application component instance at a new node when an old node running the application component instance fails. Service A and Service B are component services as each is registered at more than one node. A non-component service is only registered at a single node. Service X is non-component service and is available only at node-4.

DACX 304 is an application container for development of both EAC and CAC. DACX 304 is based on the principles of Service-Component Architecture for distributed systems. An application component in DACX 304 acts as an EAC for service methods with synchronous invocation and as CAC for service methods with asynchronous invocation. Thus, DACX 304 provides an execution environment for enterprise applications as well as communications applications.

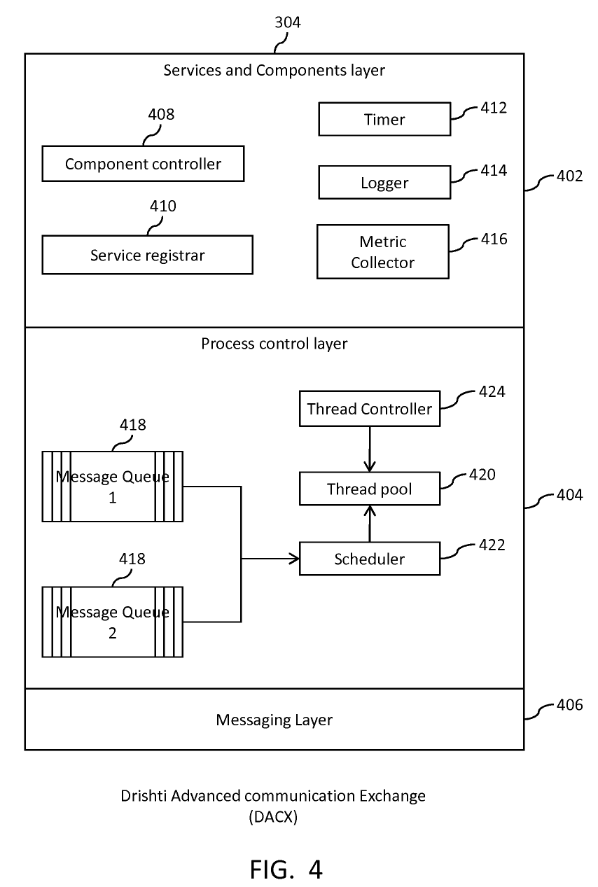

FIG. 4 is a schematic showing an exemplary embodiment of DACX 304, in accordance with an embodiment of the invention.

Constituents of DACX 304 may be grouped under a services and components layer 402, a process control layer 404, and a messaging layer 406. Services and components layer 402 comprises modules that provide facilities related to services and application components. Application developers can incorporate these facilities into application implementations while creating applications using DACX 304.

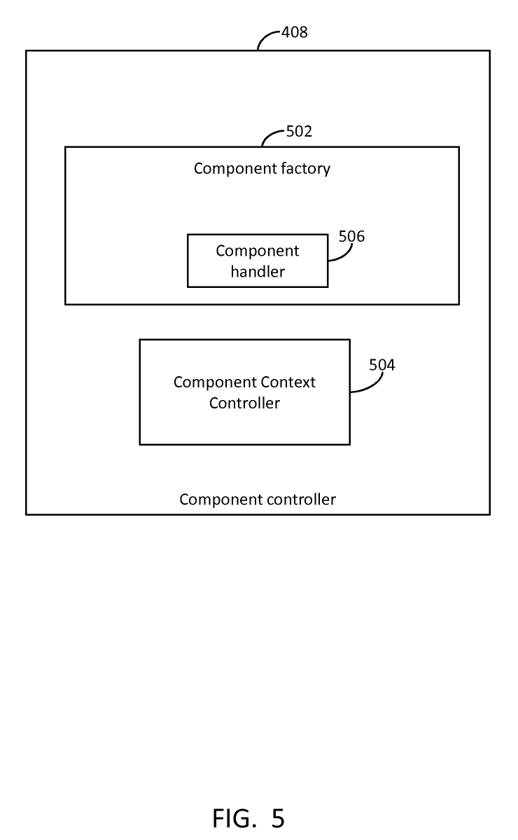

Services and components layer 402 comprises a component controller 408, a service registrar 410, timer 412, a logger 414 and a metric collector 416. Component controller 408 manages functionality of application components. Component controller 408 is described in further detail in conjunction with FIG. 5.

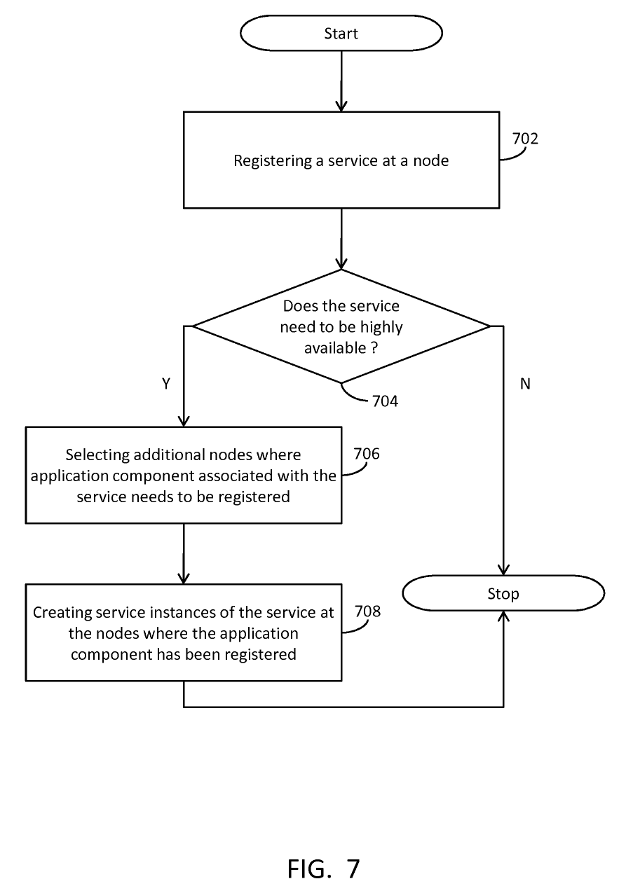

Service registrar 410 is used to register a service with DACX 304. A service is registered at a node through creation of a service instance of the service at the node. For example, node 1 has service instance of Service A, node 2 has service instance of Service B, node 4 has service instance of Service X and node 3 has service instances of Service A and Service B. A service instance is an individual instance of a service to which service requests may be directed by a requesting node. For example, the requesting node can be node 2 directing a service request towards service instance of Service A. The service request is executed by the service instance in scope of the application component associated with the service, residing at an execution node. In above example, the execution node can be node 1 or node 3 where service A and application component 306 associated with service A, are registered. Any service request for Service A will be executed by service instance of Service A running on node 1 or node 3. A service request comprises a service method having either synchronous or asynchronous invocation. The process and requirements associated with the service registration are described in conjunction with FIG. 7.

Other modules present in services and components layer 402 provide functions that facilitate application development using DACX 304. Timer 412 is used to submit timer jobs that are to be executed after the lapse of variable time duration. Timer 412 is also used to support timer jobs that recur with a constant duration as well as rescheduling of jobs on need basis. Timer jobs are used to keep track of time lapse during execution of applications. For example, timer jobs may be used to track time lapse in execution of a service request. Timer 412 in DACX 304 extends the capability of queuing mechanism of process control layer 404 to allow submission of timer jobs to be executed in specific queues having specific queuing policies. Theses queues may be the queues where service requests are queued. This allows application developers to execute timer jobs in the queues along with other service requests, according to their ordering and parallelism requirement and possibly avoid the need to synchronize execution with the other service requests. For example, while a service request is sent by a requesting node to be processed, a timer job is submitted in a queue at the requesting node. The timer job will scheduled for execution from the queue in same manner as a service request is scheduled. Scheduling of service requests for execution is described later. While the timer job is being executed, the requesting node waits for a response of the service request. If the response is not received before the execution of timer job is over, an exception will be raised that the service request response has not arrived within predefined time duration. Further, a timer job can be rescheduled for execution by timer 412 after its execution is over. For example, a timer job can be scheduled and rescheduled to keep track of time lapse in execution of a series of service requests sent from the requesting node at constant intervals.

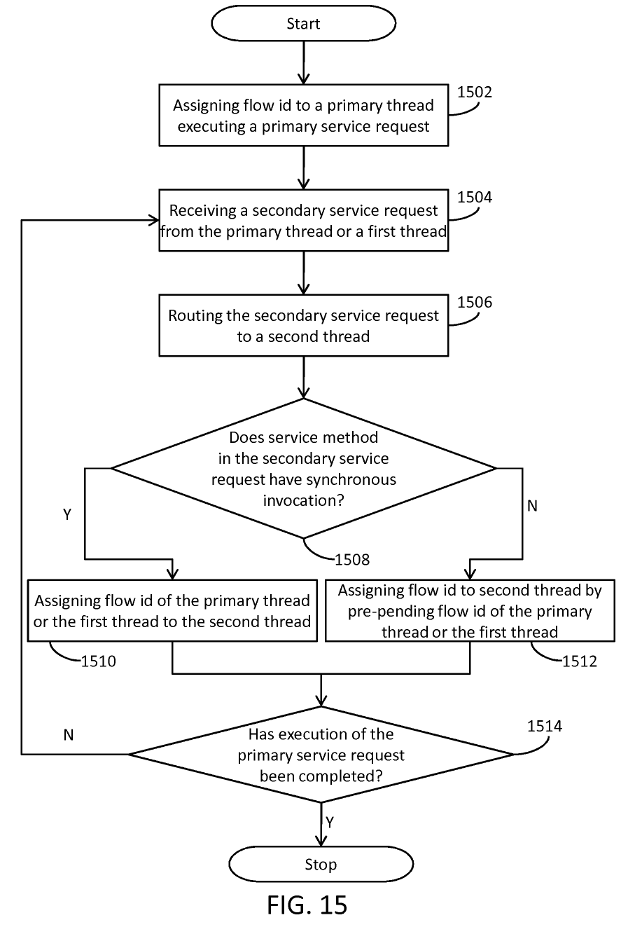

Logger 414 provides facilities for logging application data which can be subsequently used while performing maintenance and servicing operations. Logger 414 may encapsulate any logging utility and, therefore, may log messages to different kinds of destinations supported by underlying logging utility, including files, consoles, operating system logs and the like. During execution of a service request, a log message is generated. The log message is associated with flow id of thread executing the service request; the flow id is logged in to a log file along with the log message. The process of assigning flow id to a thread is explained in detail in conjunction with FIG. 15.

Metric collector 416 records statistics for metrics related to service request execution. For example, statistics for average queuing latency and average servicing time. Average queuing latency refers to the time spent by a service request in a message queue. Message queue is described in detail below. Average servicing time refers to the time taken to process a service request, starting with service invocation. Metric collector 416 supports an extensive configuration for a message queue to allow measurement of the service request execution statistics to be collected per application component instance as well as per individual method of a service(s) associated with the message queue. Metric collector 416 also can collect statistics for a queue group at a summary level, allowing fine tuning of the application deployment to achieve desired processing needs. Further, the immediate and on the fly updation of the statistics with each service request being processed allows the information to be used in the scheduler 422 to react to the situation in order to achieve the desired results.

Process control layer 404 comprises a plurality of message queue 418s, one or more thread pools 420, scheduler 422, and thread controller 424.

FIG. 4 illustrates two message queues, message queue-1 418 and message queue-2 418. Each of the plurality of message queues 418 is associated with one or more services. According to an embodiment of the invention, during registration of a service, a queuing policy is defined for the service and the service is assigned a particular queue ID which identifies a message queue associated with the service. For example, message queue-1 418 may be associated with Service A and message queue-2 418 may be associated with Service B. Further, a single message queue may be associated with more than one service. For example, message queue-1 418 may be associated with both Service A and Service B.

According to an embodiment of the invention, a message queue associated with a service stores service requests directed to a service instance of the service.

According to an embodiment of the invention, a message queue stores service requests for service methods with asynchronous invocations.

According to another embodiment of the invention, the message queue additionally stores service requests for service methods with synchronous invocations directed to a service instance of the service which need to be processed according to a sequence, e.g. the order in which they are received by DACX 304.

Queuing policy of a service defines the order of queuing of service requests in a message queue. For example, if the queuing policy is single threaded, then all the service requests, may it be for service methods with synchronous invocation or asynchronous invocation, need to be queued in the message queue. If the queuing policy is not single threaded, then all service methods with asynchronous invocations are queued in the message queue while all service methods with synchronous invocations are executed without queuing.

Thread pool 420 is a pool of threads with a variable number of threads to which a service request is submitted from a message queue for execution by one of the threads in thread pool 420. Each thread returns to thread pool 420 after executing a service request and is allocated a new service request which was submitted to thread pool 420.

Scheduler 422 manages scheduling of service requests in the message queues for submission to thread pool 420. Scheduler 422 runs a scheduling algorithm to check whether a service request from a message queue needs to be submitted to thread pool 420. The scheduling algorithm takes parameters for each message queue like the expected processing latency, service request priority, queuing policy requirements of a service and the like. Based on the result of the scheduling algorithm, scheduler 422 submits a service request to thread pool 420 for allocation of a thread.

The queuing policy of a service specifies additional strategy for scheduling execution of service requests in a message queue. There can be various strategies for scheduling the service requests stored in a message queue. Some of the strategies provided for in DACX 304 are:
1. At most one service request is picked for execution at a time.
2. Several service requests are picked for execution at a given time.
3. Service requests may be picked for execution based on discovery scope of the service requests.
4. Service requests may be picked for execution based on a priority assignment or reservation policy for end users. Such a priority assignment or reservation policy may be used to provide differentiated subscriptions to the end users. For example, the service requests from end users paying a higher subscription fee may have a higher priority compared to the service requests from end users paying a lower subscription fee.

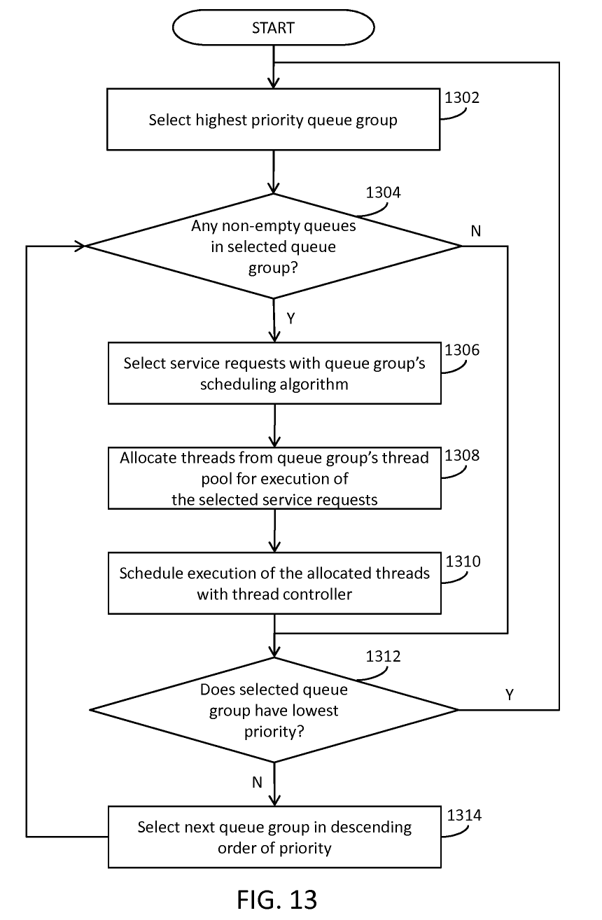

The scheduling of service requests from message queues is further controlled through the creation of queue groups. Queue group-based processing control for queued service requests is described in conjunction with FIG. 13.

Thread controller 424 allocates threads from thread pool 420 to service instances of different services for execution of the service requests submitted to thread pool 420. Thread controller 424 manages the usage of thread pool 420 based on parameters configured by an administrator. For example, thread controller 424 may restrict the maximum number of threads in thread pool 420 at any given time and the number of service requests submitted to thread pool 420 for execution.

Messaging layer 406 routes messages between nodes. The messages may be service requests, request for service reference, response messages, service registration, discovery and association messages and the like.

A request for service reference generated by a requesting node is routed by messaging layer 406 to component controller 408. Messaging layer 406 encodes application component instance information received from component controller 408 into a stub and routes the stub to the requesting node. The stub is used by the requesting node to send a service request to an execution node.

Messaging layer 406 encodes the service request into a message and routes it to the execution node. The execution node hosts an application component and associated service instance of the service, wherein the service instance executes the service request. After execution, service instance at the execution node generates a return value. Messaging layer 406 encodes the return value into a response message and routes it back to the requesting node.

FIG. 5 is a schematic of component controller 408 of the DACX ComponentService framework, in accordance with an embodiment of the invention. Component controller 408 comprises a component factory 502 and component context controller 504.

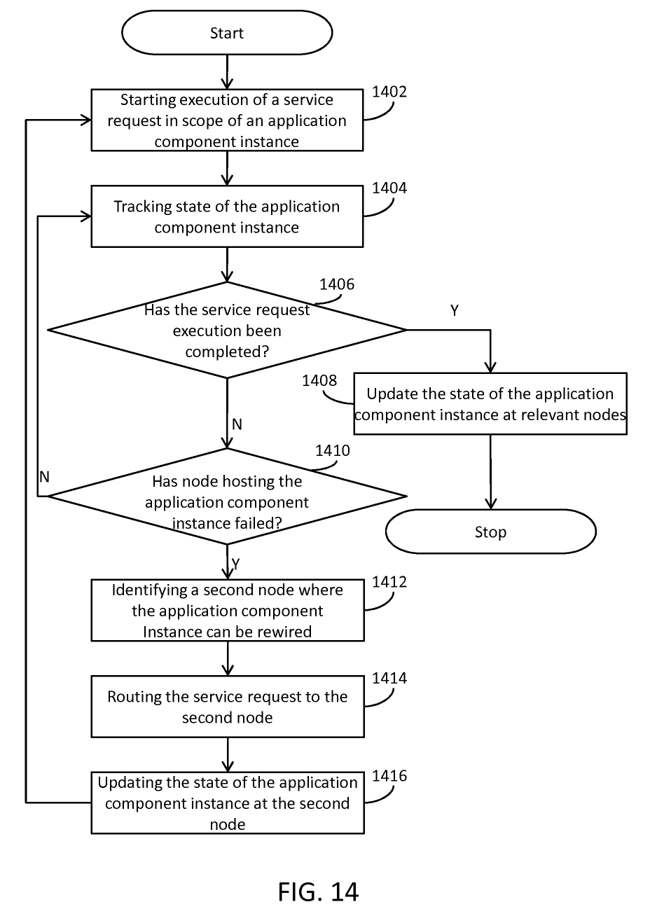

Component factory 502 performs service discovery process. The service discovery process is a requirement in a distributed system in which a plurality of nodes 302 hosts application components. In such a system, application components may become non-viable under a variety of circumstances, for example, the congestion of network channels, cyber attacks, power failures, system crashes and the like. Further, a distributed system may include mobile nodes communicating with other nodes through wireless channels. Movement of a mobile node beyond the range of a wireless network results in unavailability of application components hosted by the mobile node. Thus unavailability of a node can hamper availability of services. Therefore it is required that additional nodes should be present to which service requests can be rewired in case of node unavailability. For example, Service B is registered with node 2 and node 3. In case node 2 fails or goes out of range of wireless network, service requests for Service B can be routed to node 3. Here node 3 serves as additional node for Service B. During service discovery process, a node capable of running an application component instance associated with service is identified. In above example, if node 2 is unavailable, then during service discovery process node 3 will be identified for executing service requests related to Service B. The process of rewiring an application component instance to a new node in case of node failure is described in conjunction with FIG. 14.

The service discovery process is initiated in response to a request for service reference having a discovery scope. Each valid discovery scope gets binded to an application component instance associated with a service. Subsequent requests for service reference having same discovery scope leads to immediate mapping of the serving application component instance with the requests for service reference, until the binding is explicitly removed. For example, node 2 sends a request for service reference of Service A with discovery scope D1. Node 1 is running multiple application component instances of application component 306 having different discovery scopes. Component factory 502 tries to map discovery scopes of the request for service reference with the discovery scope of the application component instances running at node 1. In case the discovery scopes maps with application component instance A1, then component factory 502 binds the application component instance A1 with the request to service reference. Any future request for service reference of service A with discovery scope D1 will be binded to the application component instance A1 till it is functional. If the application component instance A1 stops, future request for service reference with discovery scope D1 will be binded to a second application component instance with discovery scope D1. The second application component instance may be running on node 1 itself or on node 3 where Service A is registered.

If there is no binding existing for a request for service reference of Service A, component factory 502 for application component 306 is invoked by DACX 304 to take a decision to bind the request for service reference to an existing application component instance or to create a new application component instance. In previous example, if the request for service reference with discovery scope D1 doesn't match with discovery scope of any of the multiple application component instances running at node 1, then component factory 502 takes a decision where to create a new application component instance of application component 306 with discovery scope D1. The new application component instance may be present on node 1 or node 3 depending on load distribution policy of application component 306.

After service discovery process, component factory 502 returns application component instance information to messaging layer 406. The application component instance information comprises id of the application component instance binded with the request for service reference and replica of service methods of the service. The application component instance information is encoded into a stub by messaging layer 406.

A component factory contract associated with an application component defines the load distribution policy for the application component. Load distribution policy is defined during registration of a service and its associated application component. Load distribution policy defines binding of a request for service reference of the service and subsequent service requests, with an application component instance of the application component. For example, a load distribution policy can define a binding such as, any request for service reference of Service A received from node 2 will be binded with application component instance A1 of application component 306 at node 1 and any request for service reference for Service A from node 4 will be binded to application component instance A2 at node 3. Further, the load distribution policy can also define the maximum number of binding to an application component instance. For example, maximum number of binding for application component instance A1 can be defined as 10. In case the maximum number has reached, any further request for service reference will be binded to a different application component instance running either at node 1 or node 3.

Component factory 502 further comprises component handler 506. Component handler 506 performs life-cycle management for application components. The life cycle of an application component instance is described by the following states that it may be in:
1. Started: The application component instance is made available to DACX 304 and thus can be discovered.
   a) Initialized: The application component instance is initializing and cannot serve requests but is available for discovery. All service requests made during this period would be queued at messaging queues associated with the service and would be served once initialization is complete.
2. Active: The application component instance is active and it is serving service requests.
3. Stopped: The application component instance is no longer available for serving service requests.

Component handler 506 provides the functionality for starting, initializing and stopping an application component instance.

A component handler contract defines the life cycle management operations for an application component instance of application component associated with a service. According to an embodiment of the invention, the component handler contract is used to configure how starting, initialization, and stopping are performed for an application component instance.

According to an embodiment of the invention, the component handler contract and the component factory contract are required for registering an application component with DACX 304. Application component should be registered with DACX 304 in order to be made available for the service discovery process and for execution of service requests by service instance of the service.

Component context controller 504 manages and updates state of application component instances. The state of an application component instance is stored in a generic data structure called component context with DACX 304. The information of state of an application component instance is used during node failures for recreation of the application component instance at another node where application component to which the application component instance is associated is present.

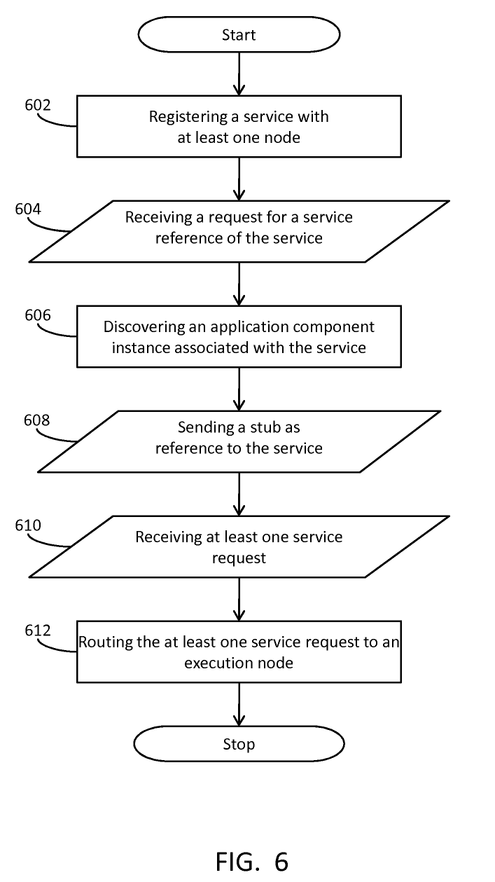

For the description of FIG. 6 to FIG. 12, the following example is used to explain the invention and various embodiments: node 2 is requesting node which generates a service request for Service A. Either of node 1 or node 3 executes the service request for service A. Hence node 1 or node 3 can be execution node. Service A comprises service methods with synchronous as well as asynchronous invocations.

FIG. 6 is a flow diagram illustrating a method for routing service requests in DACX Component Service Framework, in accordance with an embodiment of the invention.

At step 602, Service A is registered with at least one node, for example, service A may be registered with node 1. The step of registering Service A is described in detail in conjunction with FIG. 7.

At step 604, a request for service reference of Service A is received from node 2 which is the requesting node. The request for the service reference comprises of the discovery scope, typically id and type of application component requesting the service reference. The application component requesting the service reference is hosted by node 2. The type of an application component is used to identify the application component i.e. every application component is registered with a type or name with the framework.

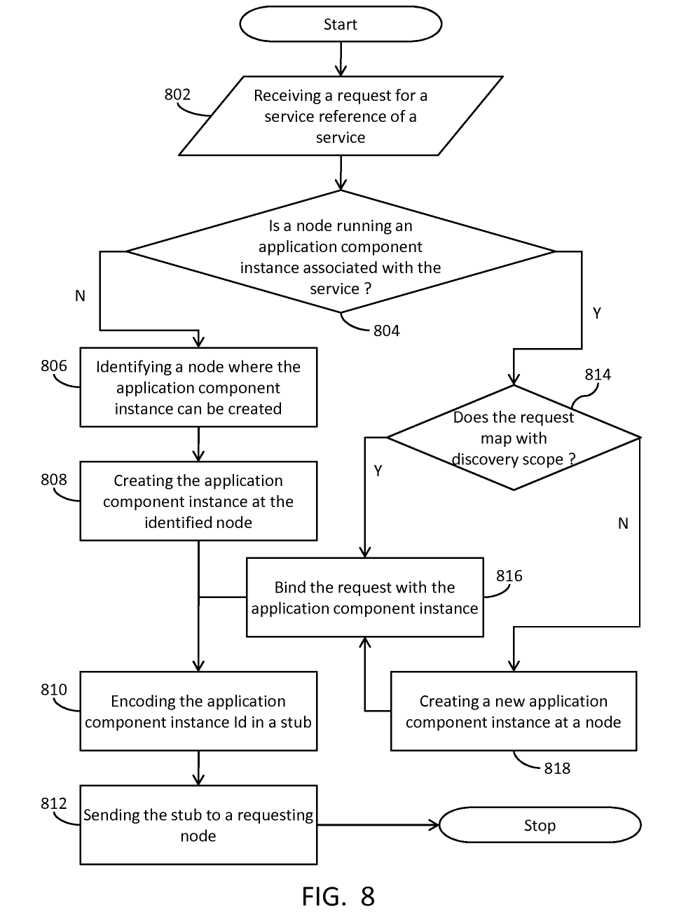

At step 606, in response to the request for service reference, an application component instance of application component 306 is discovered to which the request for service reference and following service requests related to Service A will be binded. The step of discovering the application component instance is described in detail in conjunction with FIG. 8.

At step 608, a stub is sent to node 2 in response to the request for service reference. The stub comprises information about service methods types i.e. whether the service methods of Service A are synchronous or asynchronous. For a non-component service, the stub further comprises physical address of the node at which the non-component service is registered. The physical address may be the node id which is a unique runtime identifier and also acts as the unique address of the node for non-component service requests to be routed to. In case of Service A (component service), the stub further comprises application component instance information. The application component instance information comprises logical address of the execution node through the id of application component instance associated with Service A which was discovered, and replica of service methods of Service A. The application component instance id is used during runtime to retrieve physical address of the execution node where the application component instance is running.

At step 610, at least one service request for Service A is received from node 2. Service A comprises one or more methods whose information is sent in the stub to node 2. Node 2 uses the information about service methods in the stub to generate a service request. Each service request comprises details for invocation of one service method of Service A. For invocation of each service method of Service A, multiple service requests, wherein each service request comprising details of one service method of Service A, needs to be generated. A service request further comprises id of the application component instance in the stub, the service name and parameters required for invocation of service method in the service request.

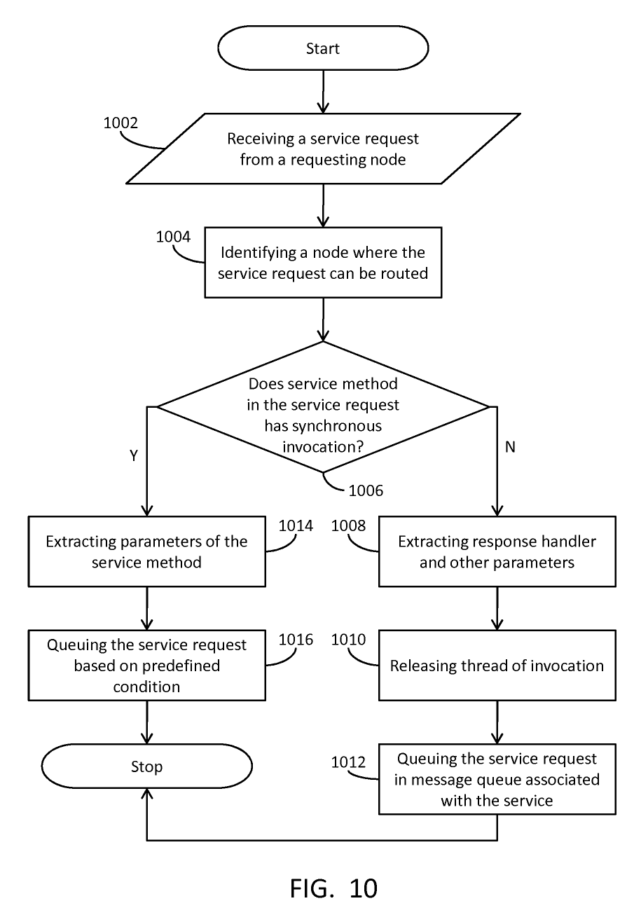

At step 612, the service request is routed to the execution node. The step of routing is described in detail in conjunction with FIG. 10.

FIG. 7 is a flow diagram illustrating registration of Service A with DACX 304, in accordance with an embodiment of the invention.

At step 702, Service A is registered at a node 1 of DACX 304. Service registration is done by service registrar 410. Prior to registering Service A, a service contract for Service A must be defined and implemented. The service contract specifies what operations Service A supports. For example, a service contract may be defined as a Java interface in which each service method corresponds to a specific service operation. The service contract may then be implemented by application component 306 associated with service A. In the above example, implementing a service contract would involve writing a Java class that implements the Java interface.

For registration of Service A, application component 306 associated with Service A needs to be registered with node 1. Service A registration further comprises defining a component factory contract and component handler contract for application component 306. Additional information such as queuing policy for Service A is also defined during registration of Service A.

At step 704, a decision is made whether Service A needs to be highly available. According to an embodiment, the decision is made by an administrator. For a highly available service, the service needs to be registered at more than one node, such that in case of a node failure, rewiring to other node running service instance of the service can be done to keep the service available. In case, Service A needs to be highly available, step 706 is executed.

At step 706, node 3 is selected as additional node where application component 306 associated with Service A needs to be registered. According to an embodiment of the invention, registration of the application component at node 3 is done when node 3 comes up in DACX 304.

At step 708, a service instance of Service A is created at node 3 where application component 306 has been registered.

In case at step 704, Service A doesn't need to be highly available or there is no need for load distribution among different nodes, then no additional nodes are searched for further registration of Service A and the process of registration gets completed.

FIG. 8 is a flow diagram illustrating the service discovery process, in accordance with an embodiment of the invention.

At step 802, DACX 304 receives a request for service reference of Service A from node 2 which is the requesting node.

At step 804, a check is made, if either of node 1 or node 3 is already running an application component instance of application component 306. According to an embodiment, the check is made by component factory 502. In case, no application component instance is running at either node 1 or node 3, step 806 is executed.

At step 806, an identification of a first node is made where an application component instance of application component 306 can be created. The first node may be node 1 or node 3 where Service A is registered. The identification is made by component factory 502 based on a load distribution policy defined with application component 306 associated with Service A.

At step 808, the application component instance of application component 306 is created at the first node. The creation of the application component instance is done by component handler 506.

At step 810, id of the application component instance and information about service methods of Service A is encoded into a stub. According to an embodiment, the encoding is done by messaging layer 406.

At step 812, the stub is sent to node 2 through messaging layer 406.

In case at step 804, at least one application component instance of application component 306 is already running at say node 1, then step 814 is executed.

At step 814, a check is made whether the request for service reference of Service A maps with discovery scope of an application component instance of application component 306 running at node 1. In case the request for service reference maps with discovery scope of an application component instance of application component 306 running at node 1, then step 816 is executed.

At step 816, component factory 502 binds the request for service reference with the application component instance having discovery scope of the request for service reference. The binding remains sticky, i.e. any new request for service reference of Service A having the same discovery scope will be binded to the same application component instance. The stub for request for service reference having same discovery scope remains unchanged i.e. the application component instance information and information of service methods remains same. A service request generated using the information in the stub will be binded to the same application component instance. Thereafter step 810 is executed.

At step 810, since the binding between the request for service reference for Service A and the application component instance already exists, hence stub is available beforehand. Hence at step 810, the stub is extracted from DACX 304.

In case, at step 814, the request for service reference doesn't map with discovery scope of any application component instance of application component 306 running at the node 1, then step 818 is executed.

At step 818, a new application component instance of application component 306 is created either at node 1 or at node 3 by component handler 506. Thereafter step 816 is executed wherein the new application component instance is binded with the request for service reference. Thereafter step 810 is executed wherein a stub is created by encoding the new application component instance information into the stub.

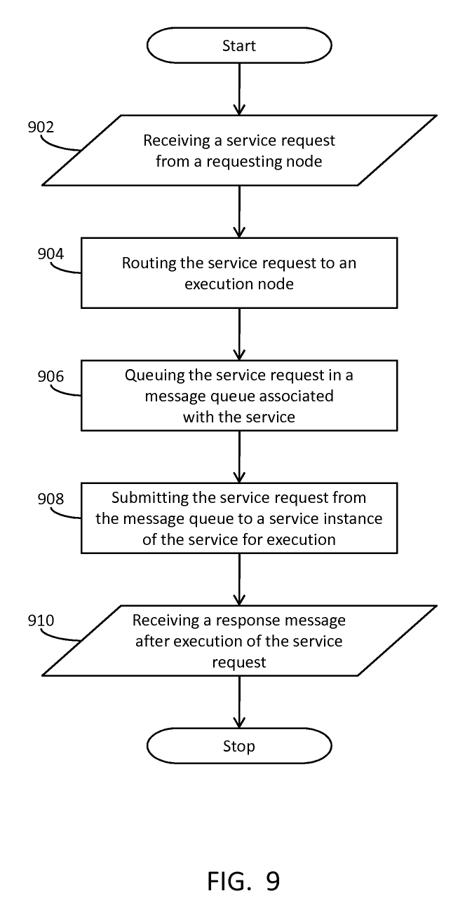

FIG. 9 is a flow diagram illustrating the process of execution of a service request, in accordance with an embodiment of the invention.

At step 902, a service request for Service A is received from node 2. The service request is made by an application component residing at node 2. The application component making the service request may be same as application component 308 associated with Service B or a different application component residing at node 2.

At step 904, the service request is routed to the execution node for executing the service request. The execution node may be node 1 or node 3 where Service A is registered. The step of routing is described in detail in conjunction with FIG. 10.

At step 906, the service request is queued in a message queue associated with Service A. The queuing is based on the queuing policy defined during registration of Service A.

At step 908, the service request is submitted to service instance of Service A running at the execution node for execution.

At step 910, after execution of the service request by the service instance in scope of the application component instance, a response message is received by messaging layer 406. Messaging layer 406 constructs the response message by encoding return value of service method in the service request which is obtained during execution of the service request.

FIG. 10 is a flow diagram illustrating the process of routing a service request from a requesting node to an execution node, in accordance with an embodiment of the invention.

At step 1002, a service request for Service A is received from node 2. The service request is made by an application component residing at node 2.

At step 1004, DACX 304 identifies the execution node where the service request needs to be routed for execution. Suppose during service discovery process, node 1 was discovered for running application component instance of application component 306 for execution of service requests related to Service A, then DACX 304 will identify node 1 to be the execution node. But there may be cases when the execution node will differ from node 1 which was discovered during service discovery process. One scenario can be when node 1 at which the application component instance of application component 306 is running goes down or fails after service discovery process. In such case, DACX 304 will rewire the application component instance from node 1 to node 3 for executing the service request. This rewiring is done without the knowledge of node 2 i.e. the requesting node. For rewiring, DACX 304 will extract physical address of the execution node using id of the application component instance in the service request at runtime. DACX 304 keeps track of state of the application component instance and the node on which it is running Thus DACX 304 can extract physical address of the execution node by associating it to the id of the application component instance in the service request. For example, in above scenario, the service request will contain id of application component instance which was running on node 1 during service discovery process. Hence at runtime DACX 304 will check whether node 1 is still available. If node 1 has failed, DACX 304 will create the application component instance at node 3 with same state as the application component instance at node 1, and route the service request to node 3. Hence in case of node failure DACX 304 rewires the service request to a new node for execution. The runtime binding of the service request with the execution node makes the stub which is used to invoke the service request, highly available.

At step 1006, a check is made on the service method invocation type in the service request, whether the service method has synchronous invocation or asynchronous invocation. In case the service method has asynchronous invocation step 1008 is executed.

At step 1008, a response handler parameter and other parameters associated with the service method are extracted from the service request and stored in a local data structure of DACX 304.

At step 1010, thread of invocation carrying the service request from node 2 to DACX 304, is released.

At step 1012, the service request is queued in a message queue associated with Service A. The queuing is done on basis of the queuing policy defined during registration of Service A. After queuing of the service request, metric collector 416 is notified of the submission of the service request in the message queue so that it can keep track of timings of the service request execution.

In case, at step 1006, the service method has synchronous invocation, then step 1014 is executed.

At step 1014, parameters associated with the service method are extracted from the service request and kept in a local data structure of DACX 304. The thread of invocation carrying the service request from node 2 to DACX 304 is made to wait for carrying back a response message to node 2.

At step 1016, based on predefined condition associated with the service A, the service request is queued in a message queue associated with Service A. According to an embodiment, the predefined condition can be queuing policy, which decides whether the service request needs to be submitted in the message queue or not. A service request having service method with synchronous invocation need not be executed in a particular order and hence need not be submitted in the message queue. On the other hand the synchronous request need to be submitted in the message queue before execution if the queuing policy is single threaded.

After queuing of the service request, metric collector 416 is notified of the submission of the service request in the message queue.

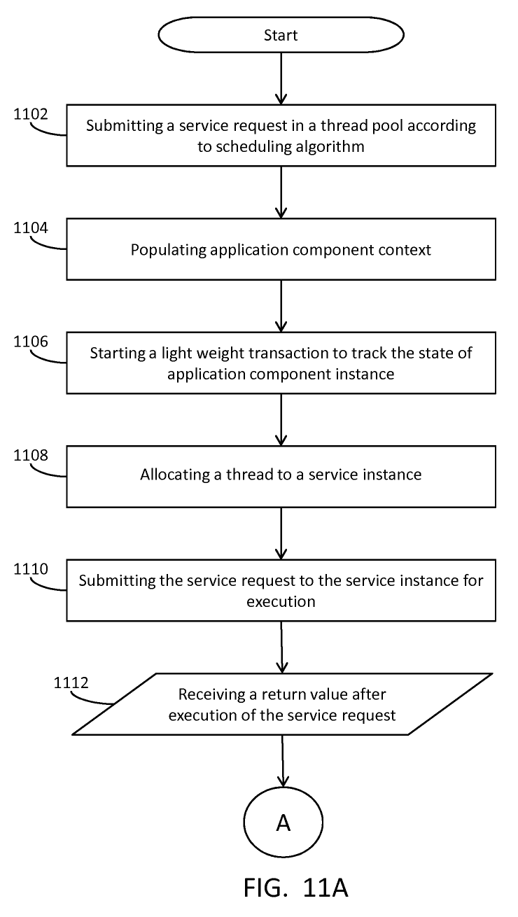

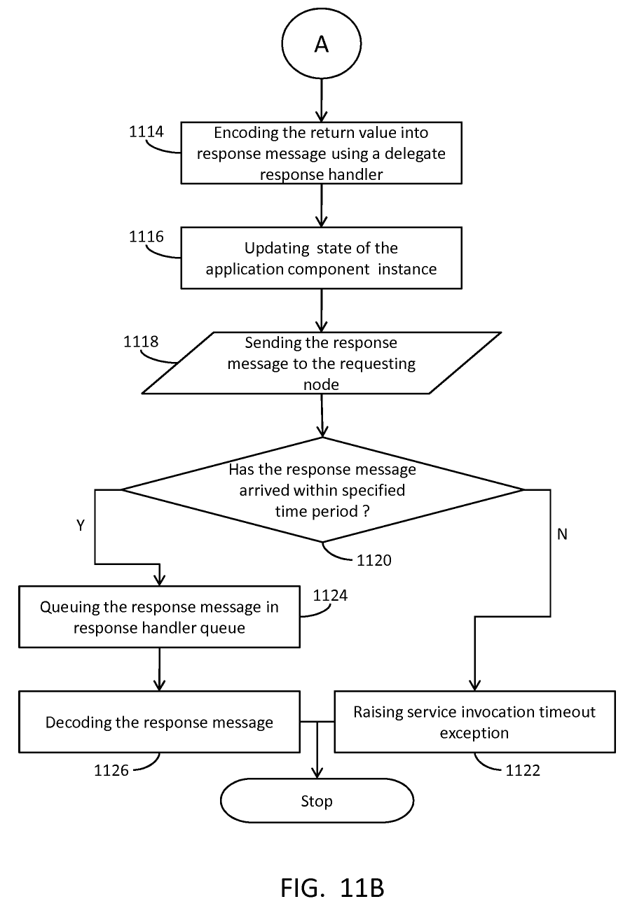

FIG. 11A and FIG. 11B are flow diagrams illustrating execution of a service method in a service request having asynchronous invocation, in DACX 304, in accordance with an embodiment of the invention.

At step 1102, a service request from a message queue associated with Service A, is submitted in thread pool 420. Thread pool 420 is associated with a queue group to which the message queue belongs. Submission of the service request to thread pool 420 is done by scheduler 422. Scheduler 422 runs a scheduling algorithm to decide the order of submitting service requests from different message queues of the queue group to thread pool 420. FIG. 13 describes an example of a scheduling algorithm. Metric collector 416 is invoked to note the timing of the submission of the service request from the message queue to thread pool 420.

At step 1104, component context of application component 306 is extracted from component context controller 504. The component context provides information about an application component instance of application component 306 and state of the application component instance to which the service request has been binded. The service request is executed by a service instance of Service A at the execution node. All service requests for Service A routed to the execution node are executed by the service instance running at the execution node. Service requests having same discovery scope are executed by the service instance in scope of the same application component instance. For example, service request 1 (SR1) and service request 2 (SR2) were binded to application component instance A1 and service request 3 (SR3) was binded to application component instance A2, wherein both the application component instances are running at the execution node. Therefore the service instance will execute SR1 and SR2 in scope of application component instance A1 i.e. if application component instance A1 is in active state, then SR1 and SR2 will be executed by the service instance. In case application component instance A1 is in stop state, then the service instance will not execute SR1 and SR2. Similarly, the service instance will execute SR3 in scope of application component instance A2.

At step 1106, a light weight transaction is started to track state of the application component instance to which the service request is binded. The light weight transaction is handled by component context controller 504. Using the light weight transaction, component context controller 504 keeps updated information about state of the application component instance to which the service request is binded. This is very useful in rewiring the application component instance at other node in case of failure of the execution node.

At step 1108, a thread is allocated to the service instance from thread pool 420 for execution of the service request.

At step 1110, the service request is submitted to the service instance. Metric collector 416 is invoked to note the timing of the submission of the service request to the service instance for execution. Thereafter execution of the service request starts. Execution of the service request comprises creation of a delegate response handler from the response handler parameter in the service request. The delegate response handler is passed as a first parameter during invocation of the service method in the service request along with other parameters in the service request. The service instance at the execution node performs the invocation of the service method and gives a return value after execution of the method. Metric collector 416 is invoked to note the timing of completion of execution of the service request.

At step 1112, return value of the service method is received by DACX 304.

At step 1114, the return value is encoded into response message by the delegate response handler.

At step 1116, state of application component instance to which the service request is binded is updated at all nodes where Service A is registered i.e. at node 1 and node 3. Updating of the state of application component instance is done by component context controller 504 using the light weight transaction. An application component instance may get destroyed because of node failures, making it is no longer available for service discovery process. To take care of such failures, the application component context information needs to be updated at all nodes where the service is registered and the application component instance is supposed to be rewired.

At step 1118, the response message is sent to node 2 which is the requesting node through messaging layer 406.

At step 1120, a check is made whether the response message has arrived within a specified time period.

In case, arrival of the response message exceeds the specified time period, a service invocation timeout exception is raised at step 1122.

In case, at step 1120, the response message is received within the specified time period, step 1124 is executed. At step 1124, the response message is submitted in a queue, wherein the queue is associated with the response handler parameter.

At step 1126, the response message is decoded to retrieve the return value of the service method.

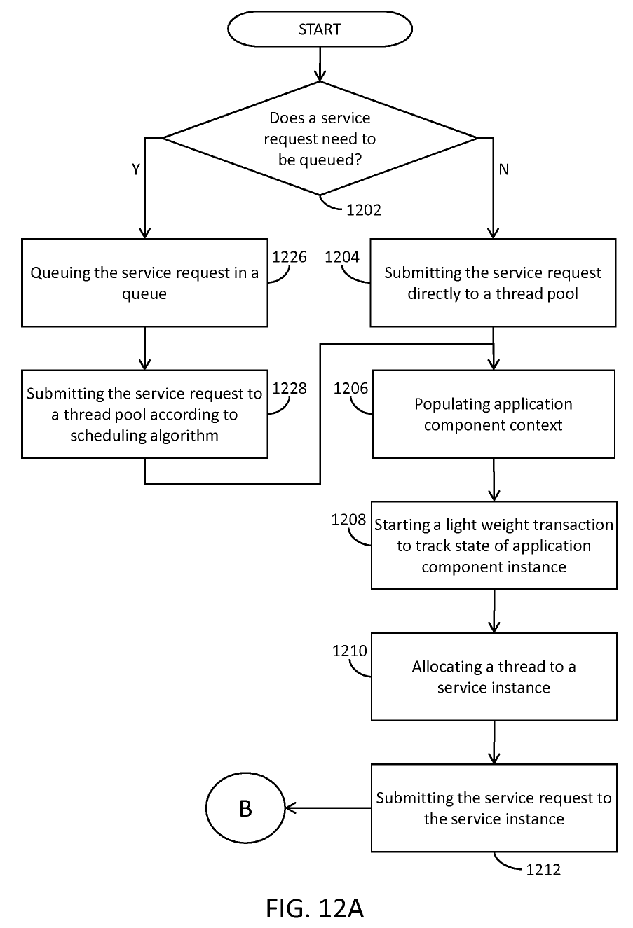

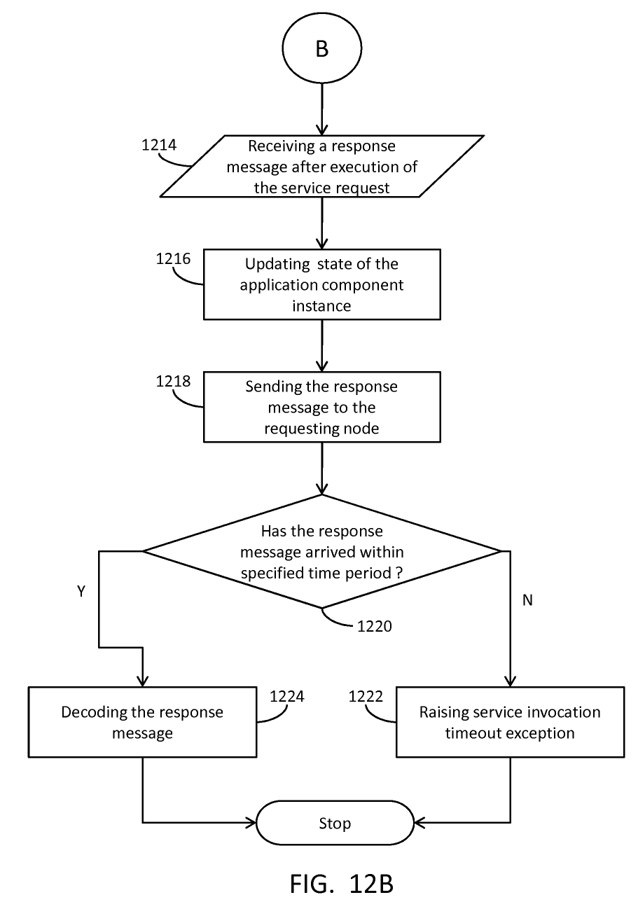

FIG. 12A and FIG. 12B are flow diagrams illustrating execution of a service method in a service request having synchronous invocation, in DACX 304, in accordance with an embodiment of the invention.

At step 1202, a check is made whether a service request for Service A received at the execution node needs to be submitted in a message queue. The decision is made on predefined condition associated with the service request. In case the service request doesn't need to be queued, step 1204 is executed.

At step 1204, the service request is submitted directly to thread pool 420. Metric collector 416 is invoked to note the timing of the submission of the service request in thread pool 420.

At step 1206, application component context of application component 306 is extracted from component context controller 504. The application component context provides information about state of an application component instance of application component 306 to which the service request is binded.

At step 1208, a light weight transaction is started to track state of the application component instance to which the service request is binded.

At step 1210, a thread is allocated to service instance of Service A at the execution node, from thread pool 420.

At step 1212, the service request is submitted to the service instance. Metric collector 416 is invoked to note the timings of starting of execution of the service request. Thereafter execution of the service request starts. The service instance invokes the service method in the service request and executes the service request.

At step 1214, after execution of the service request, a return value of the service method is received as a response message. After the execution of the service request finishes, metric collector 416 is invoked to note the timing of execution completion.

At step 1216, the state of application component instance is updated at all nodes where Service A is registered i.e. at node 1 and node 3. Updating of the state of application component is done by component context controller 504 using the light weight transaction.

At step 1218, the response message is returned to node 2 which is the requesting node in the thread of invocation through messaging layer 406.

At step 1220, a check is made whether the response message has arrived within a specified time period. In case, arrival of the response message exceeds the specified time period, then step 1222 is executed.

At step 1222, a service invocation timeout exception is raised.

In case, at step 1220, the response message is received within the specified time period, step 1224 is executed. At step 1224, the response message is decoded to retrieve the return value of the service method.

In case at step 1202, the service request needs to be queued, step 1226 is executed. At step 1226, the service request is queued in a message queue associated with Service A.

At step 1228, the service request from the message queue associated with Service A is submitted to thread pool 420, based on a scheduling algorithm. The scheduling algorithm is run by scheduler 422 to decide the order of submitting service requests from different message queues of the queue group into thread pool 420. Thereafter step 1206 is executed and the service request is processed according to the steps described above.

FIG. 13 is a flow diagram illustrating an example of a scheduling algorithm, in accordance with an embodiment of the invention. Message queues belonging to services with similar Quality-of-Service (QoS) requirements may be grouped together in a queue group. Queue groups with greater QoS requirements are assigned a higher priority compared to queue groups with fewer QoS requirements. For example, message queues associated with constant bit rate (CBR) services may be classed under high priority queue groups; whereas message queues associated with unspecified bit rate (UBR) services may be classed under low priority queue groups.

At step 1302, scheduler 422 of DACX 304 selects the highest priority queue group.

At step 1304, scheduler 422 determines if the selected queue group includes non-empty message queues. In case the selected queue group includes non empty message queues, step 1306 is executed.

At step 1306, scheduler 422 selects the service requests from the non-empty message queues based on a scheduling algorithm associated with the queue group. Further, the particular order in which the service requests are picked from particular message queues is determined by the queuing policies of the associated services.

At step 1308, thread controller 424 allocates threads from thread pool 420 associated with the queue group for execution of the selected service requests. The threads are allocated to service instances of different service which are going to execute the service requests. Thread pool 420 may be configured by an administrator to suit the requirements of queue groups associated with it. For example, thread pool 420 associated with a CBR service may be configured to accept a higher number of service requests at a time for thread allocation.

At step 1310, thread controller 424 schedules the execution of the allocated threads.

At step 1312, scheduler 422 determines if the selected queue group is the lowest priority queue group. In case, the selected queue group is not the lowest priority queue group, step 1314 is executed.

At step 1314, scheduler 422 selects the next queue group in a descending order of queue group priority. Subsequent to step 1314, scheduler 422 returns to step 1304.

If at step 1312, it is determined that the selected queue group is the lowest priority queue group, scheduler 422 proceeds to step 1302 and repeats the process for all queue groups.

FIG. 14 is a flow diagram illustrating the process of rewiring of an application component instance in case of node failures, in accordance with an embodiment of the invention.

At step 1402, execution of a service request by a service instance starts in scope of an application component instance at an execution node. The scope of the application component defines present state of the application component instance. Depending on the state of the application component instance, the service instance proceeds with the execution. If the application component instance is in active state, then the service instance executes the service request. If the application component instance is in stop state, then the service instance does not execute the service request.

At step 1404, tracking the state of the application component instance is done by component context controller 504. During the execution of the service request, the application component instance can change states from active state to stop state. The stop state can be encountered when the execution of the service request is over or the node running the application component instance, fails.

At step 1406, a check is made whether execution of the service request is complete or not. In case the execution is complete, step 1408 is executed.

At step 1408, the state of the application component instance is updated at all nodes where the service has been registered. This is helpful in future service discovery process. For example, an application component instance A1 goes in stop state after execution of service request SR1. DACX 304 receives a second service request SR2 having discovery scope of SR1. Hence it should be binded to application component instance A1. But since the information about state of the application component instance A1 is updated at all nodes where the service has been registered, so the binding will not be done as application component instance A1 is in stop state.

In case, at step 1406, the execution of the service request is not complete, then step 1410 is executed.

At step 1410, a check is made whether the execution node hosting the application component instance has failed or not. In case, a failure of the execution node has occurred, then step 1412 is executed.

At step 1412, a second node where the service is registered is discovered for rewiring the application component instance.

At step 1414, the service request is routed to the second node for further execution.

At step 1416, the state of the application component instance is updated at the second node, so that the application component instance which is rewired has same state when the execution node failure occurred. The information for updating the state of the application component instance is extracted from component context controller 504, which tracks the state of the application component instance.

Afterwards step 1402 is executed wherein the service instance at the second node executes the service request after determining the state of the application component instance.

In case at step 1410, node failure has not occurred, then step 1404 is executed wherein component context controller 504 keeps tracking the state of the application component instance.

FIG. 15 is a flow diagram illustrating the steps of flow id generation of threads executing service requests, in accordance with an embodiment of the invention.

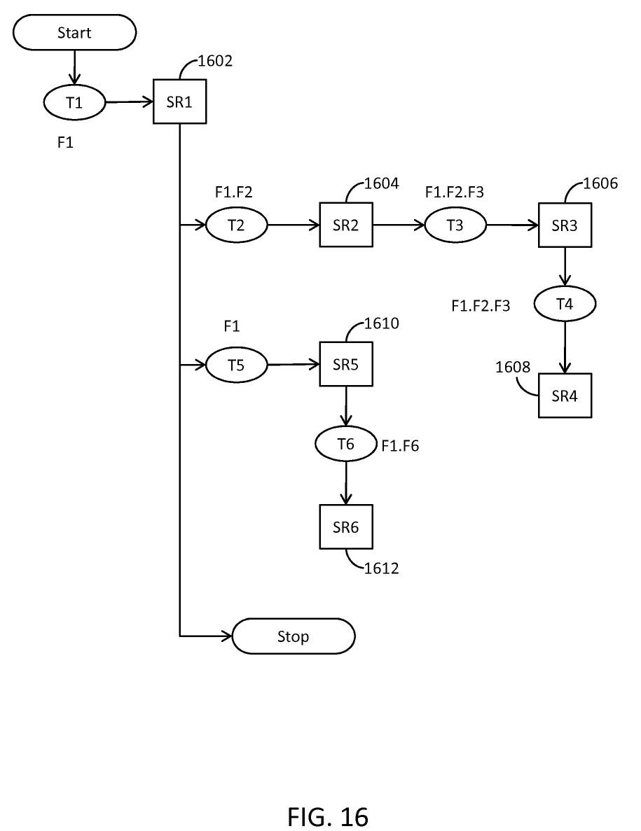

At step 1502, a flow id is assigned to a primary thread executing a primary service request. The primary service request is a first service request been generated in a sequence of subsequent secondary service requests. A secondary service request is generated in sequence of execution of the primary service request. A secondary service request may be generated by the primary thread or a thread executing any other secondary service request. FIG. 16 describes a hierarchy of primary and its secondary service requests and flow ids associated with threads executing the service requests.

At step 1504, DACX 304 receives a secondary service request. The secondary service request as stated earlier can be generated by a thread wherein the thread may be the primary thread or a first thread executing another secondary service request. This is explained in detail in conjunction with FIG. 16.

At step 1506, the secondary service request is routed for execution to a second thread. The execution of the secondary service request may take place at a node different from the node where the thread generating the secondary service request is present.

At step 1508, a check is made whether the secondary service request comprises service method with synchronous invocation. In case the service method in secondary service request has synchronous invocation, step 1510 is executed.

At step 1510, flow id of the thread generating the secondary service request is assigned to the second thread executing the secondary service request. For example, let thread T1 generates the secondary service request and thread T2 is the second thread executing the secondary service request. Thread T1 has flow id F1, then flow id assigned to thread T2 will also be F1.

In case at step 1508, the service method in the secondary service request has asynchronous invocation, then step 1512 is executed. At step 1512, flow id of the thread generating the secondary service request is pre-pended to flow id of the second thread. For example, let thread T1 has generated the secondary service request and thread T2 is the second thread executing the secondary service request. Flow id of thread T1 is F1, therefore flow id of thread T2 will be F1.F2 i.e. flow id of thread T1 will be pre-pended to flow id of thread T2.

At step 1514, a check is made whether the execution of the primary service request is complete. In case the execution of the primary service request is not complete, then step 1504 is executed where further secondary service requests are generated and flow ids are assigned to threads executing the secondary service requests according to the process described.

In case at step 1514, the execution of the primary service request is complete, the primary thread returns to thread pool 420 and the process of assigning flow ids for execution of the primary service request stops. According to an embodiment, the execution of the primary service request gets over when execution all the subsequent secondary service requests is completed.

The assigning of the flow id takes place irrespective of the node executing the service request. For example, the primary service request might be executed in node 1, and the secondary service request in node 2, but still flow id of the second thread executing the secondary service request will be F1 if the service method in secondary service request has synchronous invocation. Similarly flow id of the second thread will be F1.F2 if the service method has asynchronous invocation.

FIG. 16 is a schematic representing a sample hierarchy of a primary service request and subsequent secondary service requests and flow ids of threads executing the primary and secondary service requests, in accordance with an embodiment of the invention.

FIG. 16 shows a thread T1 which is a primary thread which initiates execution of a primary service request SR1 1602. T1 has flow id F1 assigned to it by process control layer 404. As T1 executes SR1 1602, it generates a secondary service request SR2 1604 which has service method with asynchronous invocation. Thread T2 executes SR2 1604. Hence flow id assigned to T2 is F1.F2 since SR2 1604 has service method with asynchronous invocation.

T2 generates another secondary service request SR3 1606 which also has service method with asynchronous invocation. Thread T3 executes SR3 1606. Hence flow id assigned to T3 is F1.F2.F3. Thus the pre-pending of flow id takes place in case of service method with asynchronous invocation. T3 generates another secondary service request SR4 1608 which has service method with synchronous invocation. Hence flow id assigned to thread T4 executing SR4 1608 is F1.F2.F3 i.e. same as flow id of T3.

T1 generates another secondary service request SR5 1610 after the execution of SR2 1604 is over. Execution of SR2 1604 gets completed over when execution of both SR3 1606 and SR4 1608 is over.

SR5 1610 has service method with synchronous invocation, hence thread T5 executing SR5 1610 has flow id F1 which is same as flow id of T1.

T5 further generates another secondary service request SR6 1612 during execution of SR5 1610. SR6 1612 has service method with asynchronous invocation; hence flow id assigned to thread T6 executing SR6 is F1.F6 wherein ‘F1’ is pre-pended from T5.

After the execution of thread SR6 1612 and SR5 1610 gets completed, execution of SR1 1602 gets completed.

It should be understood above illustration is given as an example of flow id generation process and should not be used to limit the scope of the invention. It is well understood that the process of assigning flow ids is applicable to any other hierarchy of service requests as well.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for routing service requests in an execution environment, the execution environment comprising a plurality of nodes, the method comprising:
a. Registering a service with at least one node, the at least one node comprising an application component, the application component being associated with the service, wherein registering comprises associating a service instance of the service with the application component;
b. Receiving a request for a service reference of the service from a requesting node, the requesting node being one of the plurality of nodes;
c. discovering an application component instance associated with the application component at a first node in response to the request for a service reference, the first node being one of the at least one node;
d. Sending a stub to the requesting node, the stub comprising an application component instance information and service method invocation types, the application component instance information being associated with the application component instance;
e. Receiving at least one service request from the requesting node, the service request being sent by the requesting node using the information in the stub; and
f. Routing the at least one service request to an execution node for execution using the application component instance information.

2. The method of claim 1, wherein the step of discovering an application component instance comprises:
a. Selecting a first node, wherein selection is done according to load distribution logic;
b. Creating an application component instance at the first node.

3. The method of claim 1, wherein the step of discovering comprises identifying an application component instance running at a first node wherein the application component instance is associated with the application component.

4. The method of claim 1 wherein the service method invocation type is one of synchronous and asynchronous.

5. The method of claim 1 wherein the execution node is the first node.

6. The method of claim 1 wherein the step of routing further comprises:
a. Identifying an execution node where the application component instance is present;
b. Routing the service request to the execution node for execution.

7. The method of claim 6 wherein the execution node is the first node.

8. A method of executing service requests in an execution environment, the execution environment comprising a plurality of nodes, a service being registered with at least one node, the at least one node comprising an application component associated with the service, a service instance of the service being associated with the application component, the service being associated with a queuing policy, the method comprising:
a. Receiving at least one service request related to the service from a requesting node, the service request being received through an invocation thread, the service request comprising an application component instance information and a service method invocation type, the application component instance information being associated with an application component instance;
b. Routing the service request to an execution node using the application component instance information, the execution node being one of the at least one node;
c. Queuing the service request for execution in a message queue at the execution node, wherein queuing is based on the queuing policy and the service method invocation type, the message queue being associated with the service;
d. Submitting the service request to the service instance for execution; and
e. Receiving a response message from the service instance after the execution of the service request.

9. The method of claim 8 further comprises the step of extracting a response handler parameter and other parameters from the service request when the service method invocation type is asynchronous.

10. The method of claim 8 further comprises the step of releasing the invocation thread after receiving the service request, when the service method invocation type is asynchronous.

11. The method of claim 8 further comprises the step of tracking the state of the application component instance during the execution of the service request.

12. The method of claim 11 further comprises the steps of:
a. Identifying an event of execution node failure during the execution of the service request, the identification being done based on the tracking;
b. Identifying a second execution node based on the identification of the event;
c. Routing the service request to the second execution node based on predefined conditions.

13. The method of claim 8, wherein the response message received is encoded using a delegate response handler for service method with asynchronous invocation.

14. The method of claim 8, wherein the step of submitting, wherein the service method invocation type is asynchronous, comprises:
a. Submitting the service request to a thread pool based on a scheduling algorithm;
b. Allocating a thread from the thread pool to the service instance; and
c. Submitting the service request to the service instance for execution.

15. The method of claim 8, wherein the service method invocation type is asynchronous, further comprising the steps of:
a. Updating state of the application component instance after the execution;
b. Sending the response message to the requesting node using a delegate response handler; and
c. Submitting the response message in a queue for processing, wherein the queue is based on the response handler parameter.

16. The method of claim 8, wherein the service method invocation type is synchronous, further comprising the steps of:
a. Updating state of the application component instance after the execution; and
b. Sending the response message to the requesting node, wherein the response message is returned in the invocation thread.

17. An execution environment, the execution environment comprising:
a. A plurality of nodes;
b. a service registrar, the service registrar configured to register a service with at least one node, the at least one node comprising an application component, each application component being associated with the service, wherein registering comprises associating a service instance of the service with each application component;
c. a component factory, the component factory configured to:
i. Receive a request for a service reference from a requesting node, the requesting node being one of the plurality of nodes;
ii. discover an application component instance associated with the application component at an first node in response to the request for a service reference, wherein discovering is done according to load distribution logic based on discovery information;
d. a messaging layer, the messaging layer configured to:
i. receive an application component instance information from the component factory;
ii. Send a stub to the requesting node, the stub comprising the application component instance information and a service type, the application component instance information being associated with the application component instance;
iii. Receive a service request from the requesting node, the service request comprising information in the stub;
iv. Route the service request to the first node for execution using the application component instance information;
v. Receive a response message from the application component after the execution of the service request;

18. The execution environment of claim 17 further comprising a process control layer, the process control layer configured to:
a. receive the service request routed by the messaging layer;
b. Queue the service request for execution in a queue at the first node, wherein queuing is based on the queuing policy and the service type;
c. Submit the service request to the application component for execution, wherein submitting is based on a scheduling algorithm;

19. The execution environment of claim 17, wherein the component factory further comprises a component handler, the component handler configured to create the application component instance.

20. The execution environment of claim 17 further comprises a component context controller, the component context controller configured to:
a. Track the state of the application component during execution of the service request; and
b. update state of the application component after execution of the service request.
